(19) United States
(12) Patent Application Publication
(10) Pub. No.: US 2007/0199787 A1
(43) Pub. Date: Aug. 30, 2007

(54) Coupling device

(75) Inventors: Mark Graf, Creston, OH (US); Fraser J. MacDonald, Farmington Hills, MI (US)

Correspondence Address: SIMPSON & SIMPSON, PLLC, 5555 MAIN STREET, WILLIAMSVILLE, NY, 14221-5406, US

(73) Assignee: LuK Lamellen und Kupplungsbau Beteiligungs KG, Buehl (DE)

(21) Appl. No.: 11/710,049

(22) Filed: Feb. 23, 2007

Related U.S. Application Data
(60) Provisional application No. 60/777,582, filed on Feb. 28, 2006.

(51) Int. Cl. F16D 23/00

(52) U.S. Cl. 192/55.61

(57) ABSTRACT

A coupling device operatively arranged between a drive unit and a rotary driven unit including a housing having first and second housing shells, a flange and a clutch assembly arranged to controllably engage a damper. The clutch assembly and damper are positioned within the housing, and the clutch assembly is arranged to directly frictionally engage the flange and first and second housing shells. The damper includes ends bearing against a portion of the flange.

### CROSS-REFERENCE TO RELATED APPLICATIONS

This application claims the benefit under 35 U.S.C. §119(e) of U.S. Provisional Application No. 60/777,582 filed Feb. 28, 2006.

### FIELD OF THE INVENTION

The present invention relates generally to coupling devices, more particularly, to a coupling device arranged to connect a drive unit and a rotary driven unit, and, more specifically, to a coupling device arranged to connect a drive unit and a rotary driven unit having a controllably engageable damper.

### BACKGROUND

Generally, coupling devices used to connect a drive unit and a rotary driven unit are well known in the art. For example, torque converters have been used to transfer energy from internal combustion engines to rotary driven units, while providing the additional benefit of torque multiplication. As these types of devices have been used for some time, vehicle developers have expectations of coupling device size and performance. Thus, new coupling devices must maintain similar performance characteristics while maintaining a compact size. Coupling devices that require no more than vehicle software changes are even more advantageous.

For example, commonly owned and therefore uncitable U.S. patent application Ser. No. 11/183,388, which is incorporated herein by reference, teaches a coupling device operatively arranged to connect an internal combustion engine of a motor vehicle and a downstream transmission. The device is a substitute for a torque converter and may include a damper. The device is designed to utilize the same installation space between the internal combustion engine and the transmission as a torque converter utilizes. The only requirement for the installation of this device is to replace the transmission/engine control software.

Recent engine and vehicle designs have presented new challenges for coupling device developers. For example, the introduction of hybrid vehicles, i.e., gas and electric motors, created the need to start and stop an internal combustion engine throughout vehicle operation. During such critical dynamic events, it is advantageous to lock out with a clutch system any damper systems included in the coupling device. Damper systems are often optimized to lower resonance points, which typically occur during engine startup, i.e., 0-800 RPM. The starting torque is transmitted through a damper/clutch assembly from the transmission to the internal combustion engine. If the clutch is not locked up during a startup event, the damper could be exposed to torque spikes created from internal combustion engine firing, which would adversely affect durability. In a hybrid system of this type, it is also imperative that the clutch does not slip during startup because the internal combustion engine and the startup motor will be phased. Any clutch slippage will adversely affect the phasing.

As can be derived from the variety of devices and methods directed at coupling devices connecting a drive unit to a rotary driven unit, many devices have been contemplated to accomplish the desired end, i.e., a coupling device having means for controllably engaging a damper, and thus providing both dampened and undampened transfer of energy between the drive unit and the rotary driven unit. Heretofore, tradeoffs between the type of coupling means, damping capabilities and size for such means were required. Thus, there has been a long felt need for a coupling device having means for controllably engaging a damper and having a size substantially similar to existing coupling devices.

### BRIEF SUMMARY OF THE INVENTION

The present invention broadly includes a coupling device having a housing with first and second housing shells, a flange and a clutch assembly arranged to controllably engage a damper. The clutch assembly and damper are positioned within the housing, and the clutch assembly is arranged to directly frictionally engage the flange and first and second housing shells. In an embodiment, the damper includes an end bearing against a portion of the flange.

In another embodiment, the coupling device includes at least one first clutch plate non-rotatably engaged with the flange and a piston arranged to frictionally engage the at least one first clutch plate with at least one of the housing shells.

In yet another embodiment, the coupling device includes at least one second clutch plate fixedly secured to one of the housing shells. In this instance, the piston may be arranged to frictionally engage the at least one first clutch plate, the at least one second clutch plate and the at least one housing shell.

In a further embodiment, the coupling device includes at least one combination fastener-damper stop. In this embodiment, the first housing shell includes at least one opening wherein the at least one combination stop is disposed. The combination stop is arranged to receive a fastener associated with the drive unit and provide a bearing surface for the damper.

A general object of the invention is to provide coupling device to connect a drive unit with a rotary driven unit.

Another object of the invention is to provide a coupling device having means to controllably engage a damper.

Yet another object of the invention is to provide a coupling device arranged to lock out a damper on demand, during critical dynamic events, e.g., engine start up and shut down.

These and other objects, features, and advantages of the present invention will become readily apparent to one having ordinary skill in the art upon reading the detailed description of the invention in view of the drawings and appended claims.

### BRIEF DESCRIPTION OF THE DRAWINGS

The nature and mode of operation of the present invention will now be more fully described in the following detailed description of the invention taken with the accompanying drawing figures, in which:

FIG. 1 is an exploded front perspective view of a coupling device of the present invention;

FIG. 2 is an exploded back perspective view of the coupling device shown in FIG. 2;

FIG. 3 is a back elevation view of a first embodiment of a coupling device of the present invention;

FIG. 4 is a cross-sectional view of the coupling device shown in FIG. 3, taken generally along line 4-4 of FIG. 3;

FIG. 5 is an enlarged cross-sectional view of the flange, piston and clutch plates shown in the encircled region 5 of FIG. 4;

FIG. 6 is a partial front perspective view of a first housing shell of FIG. 1 showing a combination fastener-damper stop fixedly secured within the housing shell;

FIG. 7 is a partial back perspective view of the housing shell of FIG. 6 showing a first damper bearing surface;

FIG. 8 is a partial front perspective view of a second housing shell of FIG. 1 having a second damper bearing surface;

FIG. 9 is a front perspective view of a hub; and,

FIG. 10 is a front perspective view of an embodiment of a clutch pack.

### DETAILED DESCRIPTION OF THE INVENTION

At the outset, it should be appreciated that like drawing numbers on different drawing views identify identical, or functionally similar, structural elements of the invention. While the present invention is described with respect to what is presently considered to be the preferred embodiment, it is to be understood that the invention as claimed is not limited to the preferred embodiment.

Furthermore, it is understood that this invention is not limited to the particular methodology, materials and modifications described and as such may, of course, vary. It is also understood that the terminology used herein is for the purpose of describing particular embodiments only, and is not intended to limit the scope of the present invention.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described.

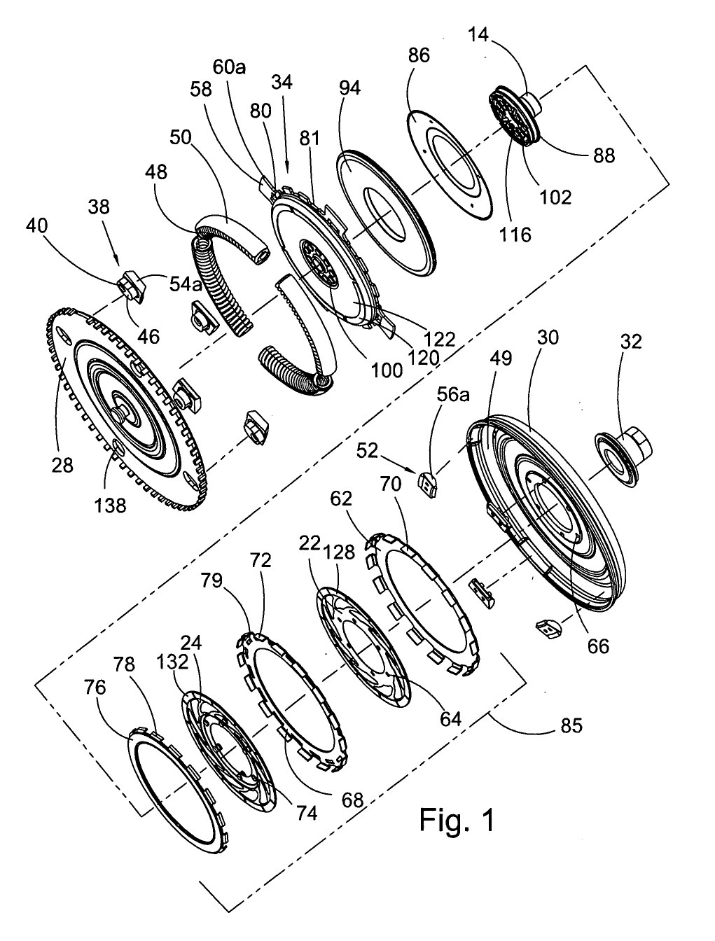

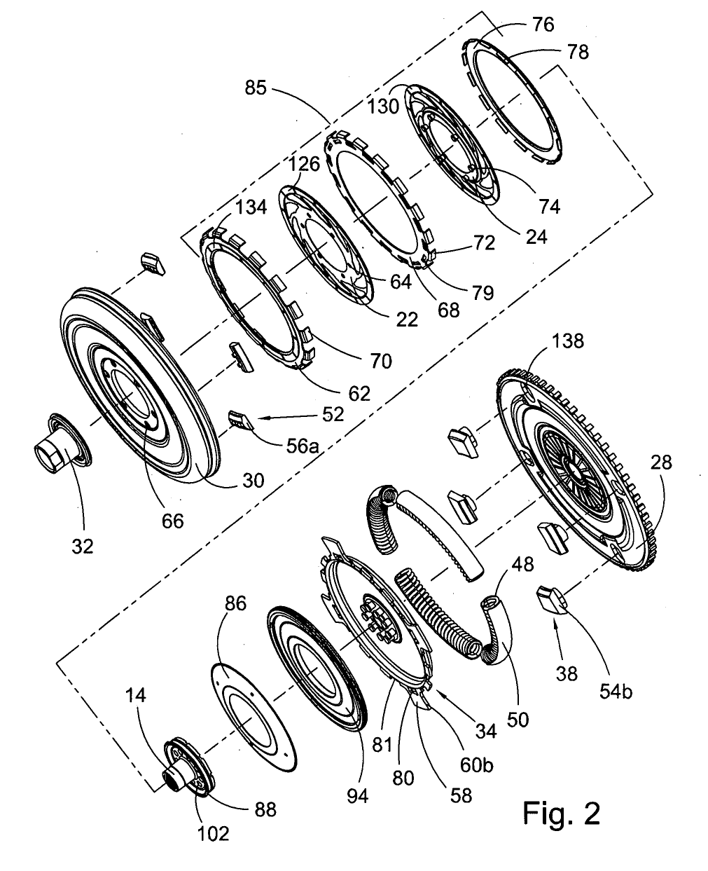

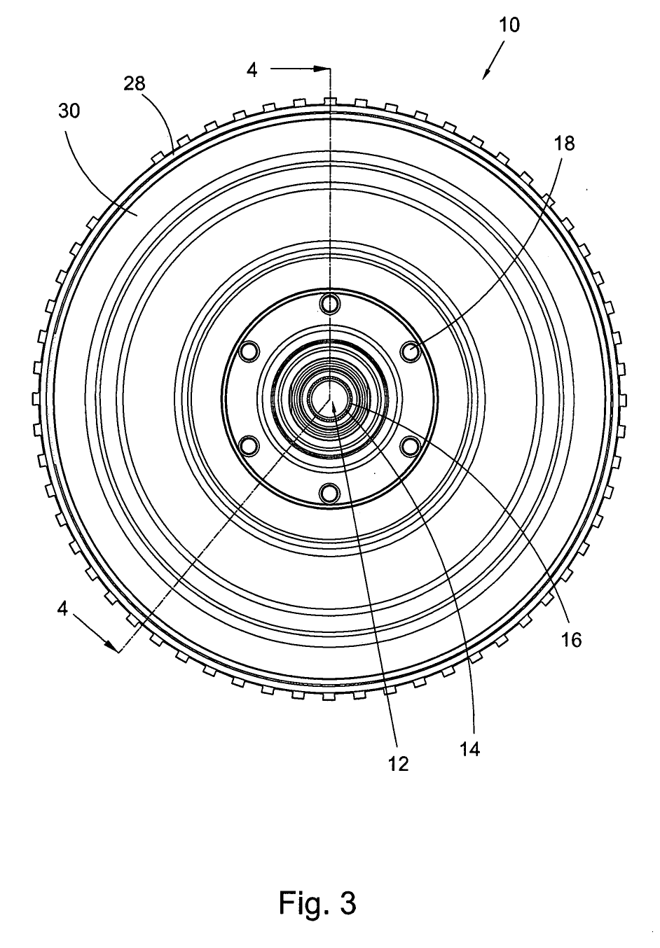

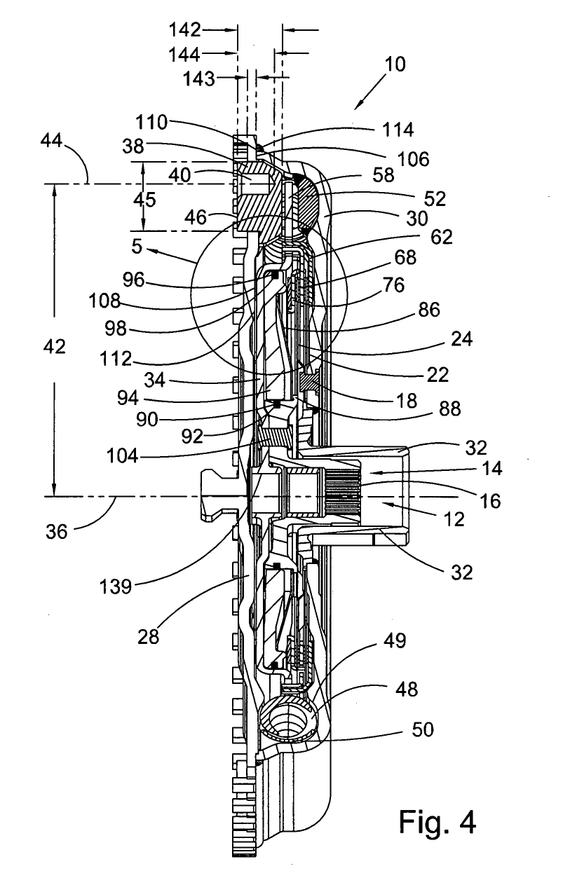

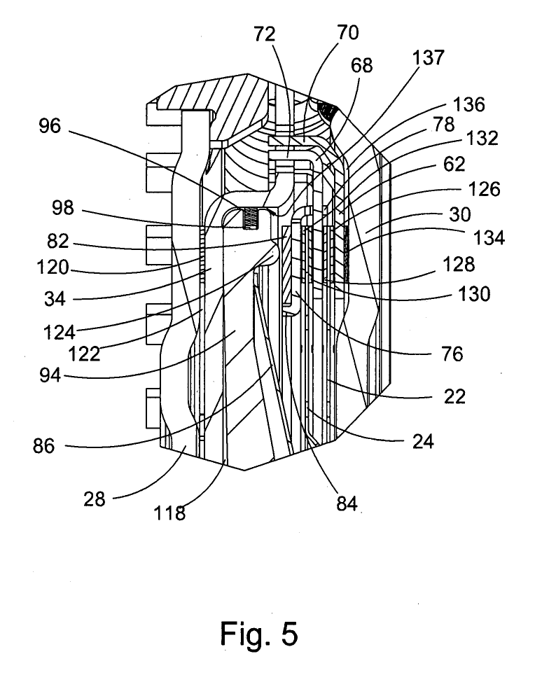

Adverting now to the figures, FIG. 1 is an exploded front perspective view of coupling device 10, while FIG. 2 is an exploded back perspective view of coupling device 10. FIG. 3 is a back elevation view of a first embodiment of coupling device 10 of the present invention, while FIG. 4 is a cross-sectional view of coupling device 10, taken generally along line 4-4 of FIG. 3. FIG. 5 is an enlarged cross-sectional view of the flange, piston and clutch plates shown in the encircled region 5 of FIG. 4. The following should be viewed in light of FIGS. 1 through 5. Coupling device 10 includes opening 12 arranged to receive an input shaft of a rotary driven unit (not shown) therein. Hub 14, positioned proximate opening 12, includes spline 16. Spline 16 engages the input shaft of the rotary driven unit, thus permitting slight axial displacement of the input shaft relative to coupling device 10 while preventing any rotational slippage between hub 14 and the shaft. A more detailed description of the nature and operation of hub 14 is included infra. Rivets 18 fixedly secure clutch plates 22 and 24 to coupling device 10. Although rivets 18 are taught as a means of fastening clutch plates 22 and 24 to coupling device 10, one of ordinary skill in the art will recognize that other fastening means are possible, e.g., welding or brazing, and that such means are within the spirit and scope of the invention as claimed.

Coupling device 10 is substantially enclosed by first and second housing shells 28 and 30, respectively. As described supra, coupling device 10 is arranged to receive an input shaft of a rotary driven unit through opening 12. Pump neck 32 forms opening 12. Pump neck 32, hub 14 and flange 34 share a common axis of rotation, i.e., axis 36. In like fashion, coupling device 10 shares axis 36 as its axis of rotation. Coupling device 10 may rotate about axis 36 when a drive unit (not shown) is fixedly secured to combination fastener-damper stops 38 via holes 40. Radius 42, i.e., the distance between axis 36 and hole center 44, depends upon design considerations of the drive unit. For example, drive units are often connected to coupling devices via a flex plate. Each flex plate design will likely have a unique attachment radius, i.e., the distance between the flex plate axis of rotation and its attachment holes. Thus, the radial position of hole 40 (radius 42) is variable, limited by length 45 of radial surface 46 of combination stop 38. Provided enough material remains between the exterior walls of combination stop 38 and hole 40, hole 40 will maintain sufficient strength to retain a fastener without the risk of a fastener dislodging from hole 40. Thus, hole 40 may be positioned anywhere within length 45 where sufficient wall material remains. Although hole 40 is shown as the attachment means in this embodiment, as one of ordinary skill in the art is aware, other attachment means are also possible, e.g., forging preconfigured studs or lugs in combination stop 38, or pre-installing a stud within hole 40 so that a nut may be used to secure a flex plate to combination stop 38, and such means are within the spirit and scope of the invention as claimed.

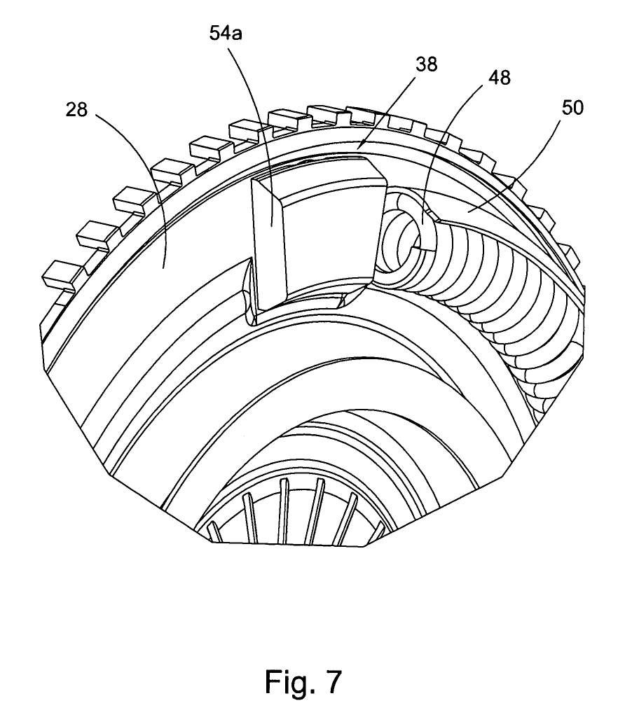

Combination stop 38 also provides a bearing surface for damper spring 48 (see FIG. 7). In the embodiment depicted, four springs 48 are disposed about the outer circumference of housing shell 30, and prevented from contacting inner surface 49 of housing shell 30 by slide channels 50. Housing shell 30 also include damper stop 52, arranged complimentarily to combination stop 38. For example, the planes of bearing surfaces 54a and 54b of combination stop 38 are aligned with the planes of bearing surfaces 56a and 56b of damper stop 52. Flange 34 includes bearing portions 58, while each bearing portion 58 includes bearing surfaces 60a and 60b. As a drive unit rotates coupling device 10, thereby housing shells 28 and 30, and thereby combination stops 38 and damper stops 52, respectively, springs 48 are also driven due to their contact with bearing surfaces 54a, 54b, 56a and 56b. Subsequently, springs 48 transfer the rotational energy to flange 34 via bearing surfaces 60a and 60b of bearing portions 58. Spikes or abnormalities in the rotational energy provided by the drive unit are dampened by springs 48 prior to transferring the energy to flange 34. Thus, the combination of bearing surfaces 54a, 54b, 56a, 56b, 60a and 60b, and the location of springs 48 permits vibration damping of the input energy supplied by an associated drive unit. In other words, under damped conditions, irregularities in the torque provided by a drive unit are reduced by this arrangement prior to transferring energy to the rotary driven unit via flange 34 and hub 14.

At times, it is desirable to lock-out the aforementioned interaction of flange 34 with springs 48 so that adverse effects are not experienced by coupling device 10, e.g., durability related failures of flange 34 or springs 48. As described supra, these types of events include what is known in the art as critical dynamic events, e.g., engine start up and shut down. Thus, providing means to lock the relative movement of flange 34 is advantageous for long term, reliable use of coupling device 10. According to the embodiment shown in FIG. 2, flange 34 may be controllably engaged and disengaged via the following configuration. First, in this embodiment, clutch plate 62 is centrally positioned within housing shell 30. Next, clutch plate 22 is similarly positioned and aligned so that rivet holes 64 of clutch plate 22 are axially aligned with holes 66 of housing shell 30. Then, clutch plate 68 is positioned within tab flanges 70 of clutch plate 62 so that tab flanges 72 of clutch plate 68 are aligned to tab flanges 70. Clutch plate 24 is then positioned so that rivet holes 74 of clutch plate 24 are axially aligned with holes 66 of housing shell 30. Rivets 18 are disposed within holes 66 of housing shell 30 and holes 64 and 74 of clutch plates 22 and 24, respectively, thereby fixedly securing clutch plates 22, 24, 62 and 68 to housing shell 30. Next, clutch plate 76 is positioned within clutch plate 68 so that tab flanges 78 of clutch plate 76 are aligned with slots 79 of clutch plate 68. Lastly, select fit shim 82 is positioned on clutch plate 76 and aligned by tab flange 84 of clutch plate 76. Clutch plates 22, 24, 62, 68 and 76 and select fit shim 82 collectively comprise clutch pack 85. It should be understood the present invention is not limited to the number and configuration of clutch plates shown and that the use of other numbers and configurations of clutch plates is within the spirit and scope of the invention as claimed.

The remainder of coupling device 10 is constructed outside of coupling device 10 prior to installation. Diaphragm spring 86 is positioned about the end of hub 14 opposite spline 16 so that diaphragm spring 86 abuts shoulder 88 of hub 14. Gasket 90 is positioned within channel 92 of hub 14, thereby providing a sealing means between hub 14 and piston 94. Additionally, gasket 96 is positioned within channel 98 of piston 94, thereby providing further sealing means between piston 94 and flange 34. Subsequently, piston 94 is disposed about hub 14 at the end opposite spline 16, so that piston 94, in part, abuts diaphragm spring 86. Then, flange 34 is positioned on hub 14 at the end opposite spline 16 so that holes 100 of flange 34 are axially aligned to holes 102 of hub 14. Lastly, rivets 104 are disposed through holes 100 and 102 fixedly securing flange 34 to hub 14, and thereby retaining diaphragm spring 86, piston 94 and flange 34, about hub 14. Although rivets 104 are taught as a means of fastening hub 14 to flange 34, one of ordinary skill in the art will recognize that other fastening means are possible, e.g., welding or brazing, and that such means are within the spirit and scope of the invention as claimed. There is no relative rotational movement between piston 94 and diaphragm spring 86, and thus there is minimal wear on piston 94. In a preferred embodiment, piston 94 is made from an aluminum alloy. Hence, piston 94 has a reduced mass and inertia, compared with a piston constructed from a more dense material. Lower inertia results in quicker clutch apply times, which are required for hybrid applications.

Select fit shim 82 is used to control the liftoff through clutch pack 85. Controlled liftoff is required to ensure minimum clutch apply times. As select fit shim 82 is used to account for various manufacturing tolerances and part variability, its thickness must be determined based upon a completed assembly. In some aspects, the hub-flange assembly is positioned within housing shell 30 and a measurement is taken between the position of surface 106 of housing shell 30 and the exposed surface of friction material 108. Then, a measurement is taken between surfaces 110 and 112 of housing shell 28. Based upon the values of these two measurements, the thickness of select fit shim 82 is calculated. The hub-flange assembly is removed, select fit shim 82, having the calculated thickness, is positioned on clutch pack 85 as described supra, and the hub-flange assembly is restored to its position within housing shell 30. Housing shell 28 is positioned on housing shell 30 so that combination stops 38, bearing portions 58 and stops 52 are all aligned to each other. Lastly, housing shells 28 and 30, are fixedly secured to each other via weld 114. Although the embodiment depicted in FIG. 2 shows weld 114 fixedly securing housing shells 28 and 30, one of ordinary skill in the art will recognize that other means of securing are possible, e.g., laser welding or brazing, and that such means are within the spirit and scope of the invention as claimed.

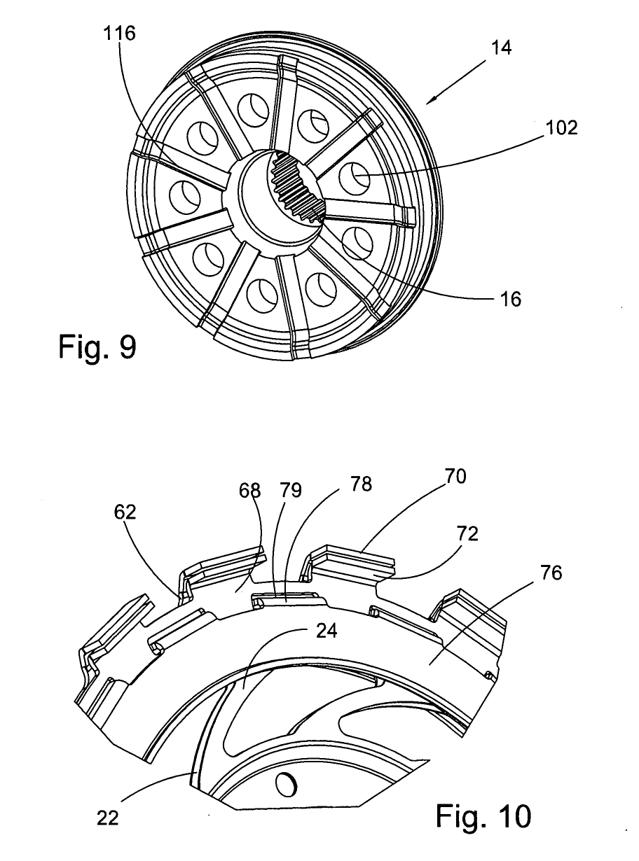

As described supra, in order to prolong the useful life of coupling device 10, flange 34 must be locked-out during critical dynamic events. In the embodiment shown in the Figures, flange 34 is locked-out according to the following method. Pressurized hydraulic fluid (not shown) is provided through the input shaft of the rotary driven unit and subsequently flows between flange 34 and hub 14 via channels 116 of hub 14 (see FIG. 9) to apply chamber 118. As the fluid pressure builds in apply chamber 118, piston 94 and flange 34 are actuated apart from each other. Friction material 120 is fixedly secured to surface 122 of flange 34, i.e., the surface of flange 34 opposite apply chamber 118. Thus, as flange 34 moves closer to housing shell 28, friction material 120 bears against surface 112 of housing shell 28, thereby directly connecting housing shell 28 and flange 34 while preventing relative rotational movement between housing shell 28 and flange 34.

Similarly, as pressure increases in apply chamber 118, piston 94 is pushed towards housing shell 30. Hence, protrusion 124 is pressed against select fit shim 82, which in turn compresses clutch pack 85. In order to provide frictional resistance during compression, clutch plates 22 and 24 are provided with friction material on both sides of each plate, while clutch plate 62 has friction material on one side. Clutch plate 22 carries friction material 126 on the surface facing housing shell 30, and friction material 128 on the surface facing housing shell 28. Similarly, clutch plate 24 carries friction material 130 on the surface facing housing shell 30, and friction material 132 on the surface facing housing shell 28. Contrarily, clutch plate 62 merely carries friction material 134 on surface 136, i.e., the surface facing housing shell 30. In view of the foregoing, piston 94 compresses clutch pack 85 by pressing select fit shim 82 against clutch plate 76, which in turn presses against friction material 132, clutch plate 24 and friction material 130, which presses against clutch plate 68, which in turn presses against friction material 128, clutch plate 22 and friction material 126, which presses against clutch plate 62, which bears friction material 134 against housing shell 30, thereby directly connecting housing shell 30 and flange 34 while preventing relative rotational movement between housing shell 30 and flange 34.

While clutch pack 85 is engaged, torque is transmitted from a starter motor in the rotary driven device to the drive unit via the following torque path: 1) through hub 14; 2) through rivets 104 between flange 34 and hub 14; 3) through flange 34; 4a) through friction material 120 on flange 34 to first housing shell 28; 4b) through clutch plates 62, 68 and 76, to clutch plates 22 and 24, to rivets 18, to second housing cover 30; 4c) through clutch plate 62 to second housing shell 30; and, 5) through combination stop 38 to the drive unit.

Clutch pack 85 is restored to its original disengaged orientation via forces provided by diaphragm spring 86. As the hydraulic fluid pressure in apply chamber 118 is reduced, diaphragm spring 86 bears against piston 94, returning piston 94 to its original rest location, i.e., bearing against flange 34.

While clutch pack 85 is disengaged, i.e., rotational movement of flange 34 is permitted, torque is transmitted from the drive unit to the rotary driven device via the following torque path: 1) through combination stops 38 on first housing shell 28 and 10 through damper stops 52 on second housing shell 30; 2) through springs 48; 3) through flange 34; 4) through rivets 104 between flange 34 and hub 14; 5) through hub 14 to the input shaft of the rotary driven unit.

In the embodiment shown in the Figures, flange 34 performs several functions. When clutch pack 85 is disengaged, flange 34 transmits torque from springs 48 to hub 14. Additionally, friction material 120 on surface 122 of flange 34 absorbs any incidental contact between flange 34 and housing shell 28, due to incidental axial movement of flange 34 when clutch pack 85 is disengaged. Contrarily, when clutch pack 85 is engaged, flange 34 and piston 94 form pressure chamber 118. Gasket 96, at the outer circumference of piston 94, seals against surface 137 of flange 34, while gasket 90, at the inner circumference of piston 94, seals against the outer circumference of hub 14. Inner circumferential surface 139 of flange 34 serves as a sealing surface to the input shaft (not shown). Friction material 120 serves as one of the six friction surfaces of the lock up clutch. Flange 34 transmits torque from clutch plates 62, 68 and 76 to hub 14.

By arranging flange 34 and clutch pack 85 as described above, coupling device 10 is arranged to prevent any slippage between the drive unit and the rotary driven unit. In systems such as hybrid vehicles, it is imperative that flange 34 does not slip during start up because the internal combustion engine and the start up motor are phased. Any slippage will adversely affect the phasing. Additionally, as the starting torque is transmitted through coupling device 10, if flange 34 is not locked during start up, flange 34 and/or springs 48 may be exposed to torque spikes created from engine firing, thereby adversely affecting durability.

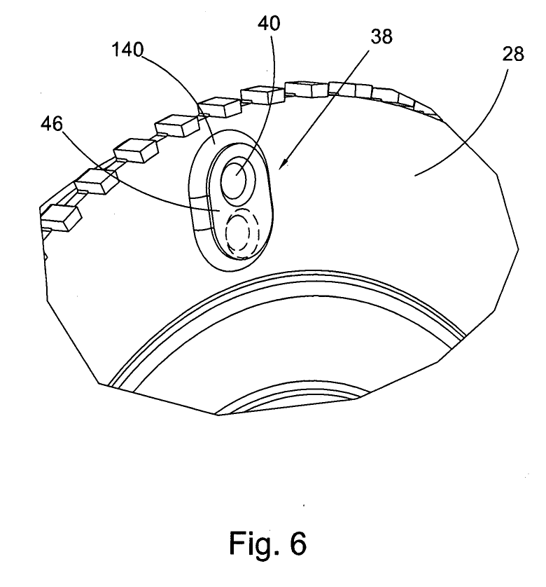

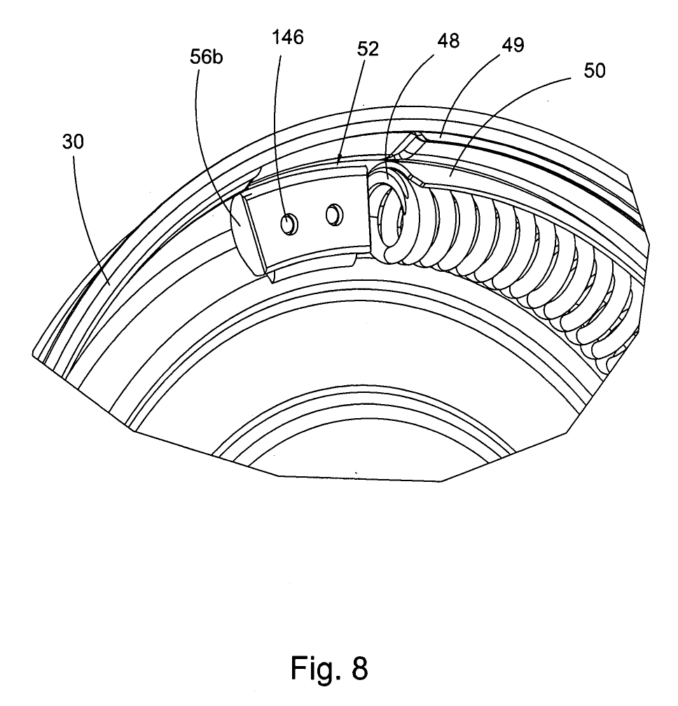

FIG. 6 is a partial front perspective view of housing shell 28 of FIG. 1 showing combination fastener-damper stop 38 fixedly secured within housing shell 28. FIG. 7 is a partial back perspective view of housing shell 28 of FIG. 6 showing damper bearing surface 54a. FIG. 8 is a partial front perspective view of housing shell 30 of FIG. 1 having damper bearing surface 56b. The following should be viewed in light of FIGS. 1 through 8. Combination fastener-damper stops 38 are positioned within openings 138 of first housing shell 28. As described supra, various drive unit designs will require unique positioning of fastening means. Thus, hole 40 of combination stop 38 may be placed anywhere along length 45 of surface 46. For example, FIG. 6 shows hole 40 arranged according to one drive unit requirement, while the similar hole shown in broken lines is arranged according to another drive unit requirement. That is, the holes have different radial distances 42. In the embodiment shown in FIG. 6, weld 140 fixedly secures combination stop 38 within opening 138. The use of a separate element 38 having a thickness 142 greater than thickness 143 of housing shell 28 is a further advantage shown in this embodiment. Thickness 142 must be sufficient to accommodate length 144 of hole 40. However, the magnitude of thickness 142 is typically greater than what is necessary for or desirable for thickness 143. Thus, by providing this material thickness for the placement of hole 40 in a separate element, i.e., combination stop 38, housing shell 28 may be manufactured using a less expensive process, e.g., stamping. Without combination stop 38, housing shell 28 would require features for an equivalent material of the thickness 142. For example, casting or machining would be needed to form a housing shell having the necessary thicknesses 142 and 144. Furthermore, thickness 142 provides combination stop 38 with material for use as a bearing surface against springs 48, i.e., bearing surfaces 54a and 54b.

Similarly, housing shell 30 is also provided with surfaces for bearing against springs 48. Protrusions 146 on the front side of housing 30 engage openings in damper stops 52. The protrusions and openings are used to position or locate the damper stops. Stops 52 are fixedly secured to housing shell 30 using any means known in the art, including but not limited to welding. Although the embodiment depicted in FIG. 8 shows protrusions 146 fixedly securing damper stops 52 to housing shell 30, one of ordinary skill in the art will recognize that other means of securing are possible, e.g., laser welding or brazing, and that such means are within the spirit and scope of the invention as claimed. As described supra, it is the combination of bearing surfaces 54a, 54b, 56a 56b, and 60a and 60b with springs 48 which provides dampening. By fixing the rotation of flange 34 to the rotation of first and second housing shells 28 and 30, respectively, movement of flange 34 relative to springs 48 is prevented. Therefore, flange 34 and springs 48 are effectively locked out from use.

As shown in FIG. 10, when plates 62 and 68 are assembled, respective pairs of tabs 70 and 72 are circumferentially aligned. In some aspects, each of these pairs of tabs is engaged with a notch 81 or opening 80 in flange 34. This arrangement advantageously enables a single notch or opening in the flange to accommodate a plurality of clutch plate tabs, thus minimizing the parts count for device 10 and minimizing the complexity of the clutch plates and flange in device 10.

Coupling device 10 broadly comprises housing shells 28 and 30, having combination stops 38 and damper stops 52, respectively, flange 34, springs 48, and means for controllably locking the rotational movement of flange 34 relative to housing shells 28 and 30. In some aspects, flange 34 is directly locked to both housing shells 28 and 30 via friction materials on the flange and assembly 85, so that rotational movement of flange 34 relative to housing shells 28 and 30 is prevented. Additionally, flange 34 may be unlocked, thereby permitting rotational movement of flange 34 relative to housing shells 28 and 30. Hence, the instant invention, coupling device 10, may be used in a damped mode, i.e., flange 34 unlocked, and an undamped mode, i.e., flange 34 locked, thereby facilitating the use of coupling device 10 in hybrid applications.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

What is claimed:

1. A coupling device operatively arranged to connect a drive unit to a rotary driven unit, comprising:
a housing comprising first and second housing shells;
a flange; and,
a clutch assembly operatively arranged to control functioning of a damper, wherein said clutch assembly, flange and damper are positioned within said housing and said clutch assembly is arranged to directly connect said flange and said first and second housing shells.

2. The coupling device of claim 1 wherein said damper further comprises an end bearing against a portion of said flange.

3. The coupling device of claim 1 wherein said clutch assembly further comprises:
at least one first clutch plate non-rotatably engaged with said flange and axially displaceable relative to said flange; and,
a piston operatively arranged to frictionally engage said at least one first clutch plate with at least one of said housing shells.

4. The coupling device of claim 3 further comprising at least one second clutch plate fixedly secured to one of said housing shells, said piston operatively arranged to frictionally engage said at least one first clutch plate, said at least one second clutch plate and said at least one housing shell.

5. The coupling device of claim 3 wherein said at least one first clutch plate further comprises at least two first clutch plates and each said at least two first clutch plates comprises respective pluralities of first protrusions, wherein said flange comprises a plurality of openings, and wherein at least one opening in said plurality of openings is engaged with a protrusion from each of said respective pluralities of first protrusions.

6. The coupling device of claim 1 further comprising at least one combination fastener-damper stop, wherein said first housing shell comprises at least one opening, said at least one combination stop is disposed within said at least one opening, and said combination stop is operatively arranged to receive a fastener associated with said drive unit and provide a bearing surface for said damper.

7. The coupling device of claim 6 wherein said at least one combination stop is fixedly secured to said first housing shell.

8. The coupling device of claim 6 further comprising a longitudinal axis; and, wherein said combination stop further comprises a radial surface, said combination stop is arranged to receive said fastener at a plurality of locations on said surface, and each of said locations is at a different radial distance from said axis.

9. The coupling device of claim 1 further comprising at least one damper stop; and, wherein said second housing further comprises at least one second protrusion, said at least one damper stop is arranged to engage said at least one second protrusion, and a position of said at least one damper stop is adjustable using said engagement.

10. The coupling device of claim 1 further comprising a shim to control liftoff through said clutch assembly.

11. The coupling device of claim 1 further comprising a spring and a hub having a shoulder; and wherein said spring is axially restrained by said shoulder.

12. A coupling device operatively arranged to connect a drive unit to a rotary driven unit, comprising:
a housing comprising first and second housing shells;
a damper; and,
at least one combination fastener-damper stop, wherein said first housing shell comprises at least one opening, said at least one combination stop is disposed within said at least one opening, and said combination stop is operatively arranged to receive a fastener associated with said drive unit and provide a bearing surface for said damper.

13. The coupling device of claim 12 wherein said at least one combination stop is fixedly secured to said first housing shell.

14. The coupling device of claim 12 further comprising a longitudinal axis; and, wherein said combination stop further comprises a radial surface, said combination stop is arranged to receive said fastener at a plurality of locations on said surface, and each of said locations is at a different radial distance from said axis.

15. The coupling device of claim 12 further comprising at least one damper stop; and, wherein said second housing further comprises at least one second protrusion, said at least one damper stop is arranged to engage said at least one second protrusion, and a position of said at least one damper stop is adjustable using said engagement.

16. The coupling device of claim 12 further comprising a clutch assembly operatively arranged to control functioning of said damper, wherein said clutch assembly and damper are positioned within said housing and said clutch assembly is arranged to frictionally engage at least one of said housing shells.

17. The coupling device of claim 16 wherein said at least one of said housing shells is said first housing shell.

18. The coupling device of claim 16 wherein said at least one of said housing shells is said second housing shell.

19. The coupling device of claim 16 wherein said at least one of said housing shells is said first and second housing shells.

20. The coupling device of claim 16 wherein said clutch assembly further comprises:
a flange;
at least one first clutch plate non-rotatably engaged with said flange; and,
a piston operatively arranged to frictionally engage said at least one first clutch plate with at least one of said housing shells.

21. The coupling device of claim 20 wherein said damper further comprises an end bearing against a portion of said flange.

22. The coupling device of claim 20 further comprising at least one second clutch plate fixedly secured to one of said housing shells, said piston operatively arranged to frictionally engage said at least one first clutch plate, said at least one second clutch plate and said at least one housing shell.

23. The coupling device of claim 20 wherein said at least one first clutch plate further comprises at least two first clutch plates and each said at least two first clutch plates comprises respective pluralities of first protrusions, wherein said flange comprises a plurality of openings, and wherein at least one opening in said plurality of openings is engaged with a protrusion from each of said respective pluralities of first protrusions.

24. The coupling device of claim 12 further comprising a shim to control liftoff through said clutch assembly.

25. The coupling device of claim 12 further comprising a spring and a hub having a shoulder; and wherein said spring is axially restrained by said shoulder.

26. A coupling device operatively arranged to connect a drive unit to a rotary driven unit, comprising:
a flange;
a first clutch plate non-rotationally engaged with said flange; and,
a second clutch plate non-rotationally engaged with said first clutch plate.

27. The coupling device of claim 26 wherein said first and second clutches comprise respective pluralities of first protrusions, wherein said flange comprises a plurality of openings, and wherein at least one opening in said plurality of openings is engaged with a protrusion from each of said respective pluralities of first protrusions.

28. The coupling device of claim 26 further comprising:
a housing comprising first and second housing shells; and,
a piston operatively arranged to frictionally engage said first clutch plate, said second clutch plate and at least one of said housing shells.

29. The coupling device of claim 28 further comprising a damper having an end bearing against a portion of said flange.

30. The coupling device of claim 28 further comprising a third clutch plate fixedly secured to one of said housing shells, said piston operatively arranged to frictionally engage said first clutch plate, said second clutch plate, said third clutch plate and said at least one housing shell.

31. The coupling device of claim 30 further comprising:
at least one combination fastener-damper stop, wherein said first housing shell comprises at least one opening, said at least one combination stop is disposed within said at least one opening, and said combination stop is operatively arranged to receive a fastener associated with said drive unit and provide a bearing surface for said damper.

32. The coupling device of claim 31 wherein said at least one combination stop is fixedly secured to said first housing shell.

33. The coupling device of claim 31 further comprising a longitudinal axis; and, wherein said combination stop further comprises a radial surface, said combination stop is arranged to receive said fastener at a plurality of locations on said surface, and each of said locations is at a different radial distance from said axis.

34. The coupling device of claim 26 further comprising at least one damper stop; and, wherein said second housing further comprises at least one second protrusion, said at least one damper stop is arranged to engage said at least one second protrusion, and a position of said at least one damper stop is adjustable using said engagement.

35. The coupling device of claim 26 further comprising a clutch assembly operatively arranged to control functioning of said damper, wherein said clutch assembly and damper are positioned within said housing and said clutch assembly is arranged to frictionally engage at least one of said housing shells.

36. The coupling device of claim 35 wherein said at least one of said housing shells is said first housing shell.

37. The coupling device of claim 35 wherein said at least one of said housing shells is said second housing shell.

38. The coupling device of claim 35 wherein said at least one of said housing shells is said first and second housing shells.

39. The coupling device of claim 26 further comprising a shim to control liftoff through said clutch assembly.

40. The coupling device of claim 26 further comprising a spring and a hub having a shoulder; and wherein said spring is axially restrained by said shoulder.
